(19) United States
(12) Patent Application Publication
(10) Pub. No.: US 2024/0348563 A1
(43) Pub. Date: Oct. 17, 2024

(54) SYSTEM AND METHOD TO IDENTIFY IMBALANCE AND ENABLE MID-FLOW REBALANCING

(71) Applicant: Microsoft Technology Licensing, LLC, Redmond, WA (US)

(72) Inventors: Sumit MAHESHWARI, Westford, MA (US); Gopi Mallikharjun BHIMAVARAPU, Hyderabad (IN); Ronaid Mark PARKER, Manchester, MA (US)

(21) Appl. No.: 18/300,909

(22) Filed: Apr. 14, 2023

(51) Int. Cl. H04L 49/50; H04L 47/62; H04L 49/00

(52) U.S. Cl. CPC H04L 49/501; H04L 47/621; H04L 49/3063

(57) ABSTRACT

An internal flow traffic controller of a multi-core processing system redirects packets among a plurality of processing cores with stateful flow awareness. The packets belong to flows of network traffic at a packet forwarding node of a 5G network or beyond. The internal flow traffic controller may include a memory storing computer-executable instructions; and a processor configured to execute the computer-executable instructions. The internal flow traffic controller is configured to distribute new incoming flows of network traffic to one of the plurality of processing cores; identify, based on an imbalance among the plurality of processing cores, an overloaded processing core to rebalance; identify a subject flow to move from the overloaded processing core; identify a target processing core with a lowest utilization; and migrate processing of the subject flow from the overloaded processing core to the target processing core.

### BACKGROUND

In communications networks, various devices may process flows of packets using a multi-core architecture. In such an architecture, each core may handle separate thread of execution. For best performance, such an architecture may avoid switching thread contexts between cores. A packet processing device with a multi-core architecture may utilize a hashing function to balance incoming flows among the multiple cores. For example, the hashing function may operate on an internet protocol (IP) 5-tuple including a source address, source port, destination address, destination port, and protocol to select a core for processing the flow.

With the current load-balancing mechanisms being employed in the industry, there is a stickiness associated with a flow after it has been assigned to a core during flow creation and it continues to be served by the same core throughout the life of the flow. Many times, it had been observed that after a certain period, core utilization seems to be skewed where one or more cores would be running beyond a threshold level from the median score of combined core utilization and certain other cores would be running underutilized. If no new flows get created, then this skew would continue, and an end-user experience would still differ from the expectation.

After a certain duration, when using conventional load-balancing algorithms, there is a deviation in the flows that are distributed across the cores. This situation demands either to reduce the new flows on a particular core, or that a new flow is hashed to be on the core which does not have remaining capacity. In either case, the new flows would be underserved. In such scenarios, one approach is to use a finer hashing algorithm, but it is again observed that any hashing algorithm will eventually fill up one of the cores to its limit. Another solution to overcome this problem is to increase the number of cores, thereby increasing the distribution of the flows, but this solution increases costs. Therefore, the existing solutions do not solve the problem of core imbalance due to flow distribution.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an internal flow traffic controller for redirecting packets with stateful flow awareness among a plurality of processing cores, including: a memory storing computer-executable instructions; and a processor configured to execute the computer-executable instructions to cause the internal flow traffic controller to: distribute new incoming flows of network traffic to one of the plurality of processing cores; identify, based on an imbalance among the plurality of processing cores, an overloaded processing core to rebalance; identify a subject flow to move from the overloaded processing core; identify a target processing core with a lowest utilization; and migrate processing of the subject flow from the overloaded processing core to the target processing core.

In some aspects, the techniques described herein relate to a method of redirecting packets with stateful flow awareness among a plurality of processing cores, including: distributing new incoming flows of network traffic to one of the plurality of processing cores; identifying, based on an imbalance among the plurality of processing cores, an overloaded processing core to rebalance; identifying a subject flow to move from the overloaded processing core; identifying a target processing core with a lowest utilization; and migrating processing of the subject flow from the overloaded processing core to the target processing core.

In some aspects, the techniques described herein relate to a non-transitory computer-readable medium storing computer-executable instructions, that when executed by a processor including a plurality of processing cores, cause the processor to: distribute new incoming flows of network traffic to one of the plurality of processing cores; identify, based on an imbalance among the plurality of processing cores, an overloaded processing core to rebalance; identify a subject flow to move from the overloaded processing core; identify a target processing core with a lowest utilization; and migrate processing of the subject flow from the overloaded processing core to the target processing core.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture of a communications network with a multi-core device, in accordance with aspects described herein.

FIG. 2 is a diagram of an example of a multi-core device with an internal flow traffic controller, in accordance with aspects described herein.

FIG. 3 is a diagram showing load imbalance among processing cores, in accordance with aspects described herein.

FIG. 4 is a logical flow diagram of a process for flow rebalancing in a multi-core device, in accordance with aspects described herein.

FIG. 5 is a message diagram of processes and messages for migrating a flow from a first core to a second core, in accordance with aspects described herein.

FIG. 6 is a flow diagram of redirecting packets with stateful flow awareness among a plurality of processing cores, in accordance with aspects described herein.

FIG. 7 is a schematic diagram of an example of a device for performing functions of flow rebalancing described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

Conventional solutions for flow distribution define a static flow distribution table or a flow selection based on a stateless machine that does not take inputs from other modules. For example, the flow selection may be based on only the internet protocol (IP) 5-tuple. Other solutions provide a weight-based mechanism; however, the weights are statically assigned per flow and are not updated during run-time. One problem with such approaches is that little information is known about a flow upon creation. A flow is created based on a first packet to arrive with a different IP 5-tuple. Characteristics such as a volume or duration of the packet flow are not known from the IP 5-tuple, and may not be predictable based on a first packet. Most of the load balancing algorithms lead to core imbalance, both instantaneously, and in long-term. A core imbalance is defined as a skew in the distribution of flows. The deviation can be noticed via the parameters such as difference in the utilization of each core, number of flows per core, packets processed per core per second, queue depth at each core, burst delays, etc. Core processing skew typically occurs when several high volume and persistent flows are distributed to the same core, while lower volume or shorter duration flows are assigned to other cores. The impacts of this imbalance can lead to inefficient usage of virtual machine (VM)/Container/Cloud/Bare metal resources, suboptimal traffic performance, and restricted core utilization.

In an aspect, the present disclosure provides an internal traffic controller for dynamic flow distribution and mid-flow rebalancing to improve the overall flow distribution and core utilization. The internal traffic controller may be a process executing on a multi-core device with other threads of execution for processing network traffic (e.g., IP packets). Initially, new incoming flows of network traffic are distributed to one of the processing cores. For example, a hashing algorithm may initially distribute the new incoming flows. The internal flow traffic controller may identify an overloaded processing core based on an imbalance (e.g., deviation in processing metrics) among the processing cores. The internal flow controller may select the overloaded processing core for rebalancing. To rebalance the cores, the internal flow controller may identify a subject flow to move from the overloaded processing core. For example, the subject flow may be a largest volume flow. The internal flow controller may identify a target processing core with a lowest utilization. The internal flow controller may migrate processing of the subject flow from the overloaded processing core to the target processing core.

In some aspects, the internal traffic controller may use a utilization score for identifying the overloaded processing core and/or identifying the target processing core to distribute the new incoming flows. Additionally, the internal traffic controller may use the utilizations core for distributing the new incoming traffic flows to the processing cores. Further, the internal traffic controller may dynamically update a scoring algorithm for the utilization score, for example, based on and error between predicted utilization scores and measured performance metrics.

Implementations of the present disclosure may realize one or more of the following technical effects. The use of flow weights and a core score to improve the flow distribution and core utilization by initiating mid-flow rebalancing may reduce a skewed load distribution among processing cores and improves performance of packet processing system. For example, latency of processing individual packets may be decreased due to shorter queues at an overloaded processing core, and overall throughput may be decreased. Additionally, dynamically updating a scoring algorithm for the processing cores to improve performance (e.g., minimize prediction error) may result in effective mid-flow rebalancing that improves desired performance metrics. Further the core scoring algorithm may be used for initial flow assignment to reduce the likelihood of a core skew condition.

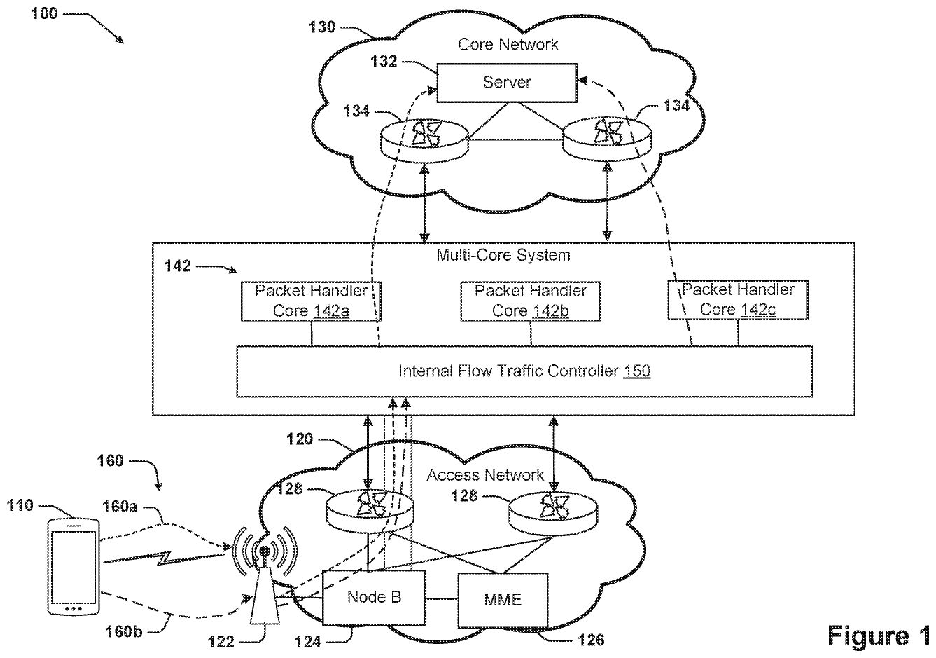

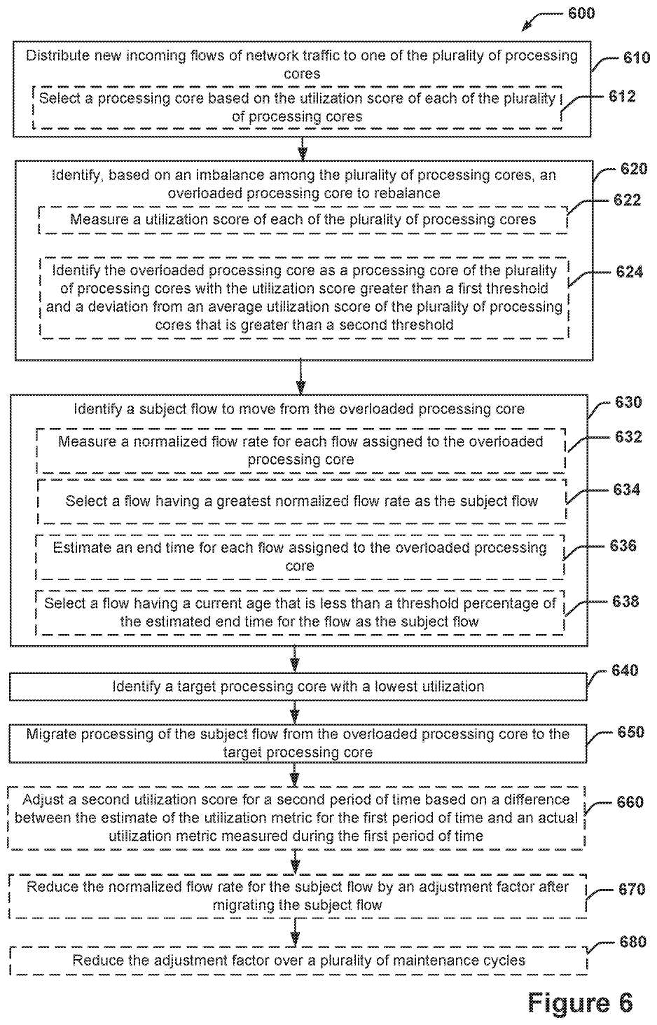

Turning now to FIGS. 1-7, examples are depicted with reference to one or more components and one or more methods that may perform the actions or operations described herein, where components and/or actions/operations in dashed line may be optional. Although the operations described below in FIG. 6 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a diagram of an example of an architecture of a communications network 100 with a multi-core system 140. The communications network 100 may be, for example, a virtualized radio access network (RAN), although the concepts described herein are applicable to other communications networks. In some implementations, the communications network 100 may be a fourth generation (4G) network, fifth generation (5G) network, or beyond. These example communications networks are part of a continuous mobile broadband evolution promulgated by Third Generation Partnership Project (3GPP) to meet new requirements associated with latency, reliability, security, scalability (e.g., with Internet of Things (IoT)), and other requirements. The communications network 100 may provide access for user equipment (UEs) 110. The communications network 100 may include an access network 120 and a core network 130. The access network 120 may include radio units 122, a base station such as a node B 124, a mobility management entity (MME) 126, and one or more routers 128.

The radio units 122 may include antennas configured to transmit and/or receive radio frequency (RF) signals. In some implementations, the radio units 122 may include RF processing circuitry. For example, the radio units (RUs) 122 may be configured to convert the received RF signals to baseband samples and/or convert baseband samples to RF signals. The RUs 122 may be connected to a node B 124, which may a dedicated hardware device or a virtualized device implemented on a datacenter. The node B 124 may perform specific RAN protocol stacks including, for example, physical (PHY) layer, media access control (MAC) layer protocol stacks, radio link control (RLC) layer, and a radio resource control (RRC) layer. The MME 126 may control mobility of a UE 110 between RUs 122 and/or node Bs 124. For example, the MME 126 may forward session information between node Bs. 124 when a UE 110 is handed over.

The core network 130 may perform higher layer network functions. For example, the core network 130 may instantiate network functions such as one or more Access and Mobility Management Functions (AMFs), a Session Management Function (SMF), and a User Plane Function (UPF). These network functions may provide for management of connectivity of the UE 110. For example, the UPF may provide processing of user traffic to and from the Internet. For instance, a UPF may receive user traffic packets and forward the packets to a server 132 via one or more routers 134.

In an aspect, one or more packet forwarding entities may be implemented as a multi-core system 140. In particular, a stateful packet forwarding entity may be implemented as a multi-core system 140. For instance, the UPF may store state information about flows and process packets based on the state information. Other examples of stateful packet forwarding entities include a packet data gateway or a firewall. A multi-core system 140 may be used for such stateful packet forwarding entities to take advantage of multi-threaded parallel processing capabilities of multiple processing cores 142. The multi-core system 140 includes a plurality of processing cores 142. For example, the multi-core system 140 may include a central processing unit (CPU) such as a server grade X86 processor. The multi-core system may have one or more physical chips that provide a plurality of virtual CPUs (vCPUs). Each vCPU may be able to handle a thread of execution in parallel with the other vCPUs. In a general purpose multi-core system, an operating system may use context switching to assign different threads of execution to vCPUs as needed.

Typically, a stateful packet forwarding entity on a multi-core system 140 may lock a plurality of vCPUs to certain threads of execution for packet processing. For instance, in an implementation, a plurality of the processing cores 142 (e.g., vCPUs) may be locked to a packet processing thread of execution using a pull mode driver that occupies the processing core 142 at all times. Locking a thread of execution to a processing core 142 may reduce the overhead of context switching among threads and improve performance of the packet processing. As illustrated, the multi-core system 140 may include a plurality of packet handler cores 142 (e.g., core 142a, 142b, and 142c). In some implementations, the multi-core system 140 may also execute an internal flow traffic controller 150 that is configured to distribute traffic flows among the processing cores 142 that are dedicated to packet processing. The internal flow traffic controller 150 may execute on one or more other cores (not shown).

As an example of packet processing within a communications network 100, processing for an uplink traffic flow from the UE 110 to the server 132 is described. The UE 110 may have multiple flows 160 (e.g., a first flow 160a and a second flow 160b) within a session that communicate with the server 132 (for example, using different protocols or session identifiers). The UE 110 sends a packet to the server 132 via the access network 120. The access network 120 routes the packet to the multi-core system 140. For instance, the node B 124 may be configured with a tunnel (e.g., a general packet radio service (GPRS) tunneling protocol (GTP) tunnel) to a UPF implemented on the multi-core system 140. A multi-core system 140 may be used to implement other packet forwarding nodes in the communications network 100. In some implementations, to meet the latency goals for 5G networks and beyond, the multi-core system 140 may be designed to minimize queuing and processing time for network traffic packets traversing the multi-core system 140.

The internal flow traffic controller 150 may decide the packet processing core based on a hash. The selected core 142 (e.g., a first packet handler core 142a) processes the packet and routes the packet to the server 132. With conventional flow assignment based on hashing, each flow for a session may be assigned to the same core 142, for example, based on a session identifier. Such an assignment scheme may contribute to core skew by assigning multiple flows to the same core. With a more sophisticated hashing algorithm, the first flow 160 and the second flow 162 may be assigned to different processing cores (e.g., the first packet handler core 142a and the third packet handler core 142c). While better distribution of flows may improve load balancing among the cores 142, the hashing algorithm may not consider information about CPU utilization of flow characteristics to assign the core 142 to each flow. Accordingly, large volume flows may end up assigned to the same core 142, which may result in uneven utilization of the cores 142 and performance degradation.

In an aspect, the internal flow traffic controller 150 is configured to dynamically rebalance flows among the plurality of processing cores 142. The internal flow traffic controller 150 is configured to distribute new incoming flows of network traffic to one of the plurality of processing cores. The internal flow traffic controller 150 is configured to identify, based on an imbalance among the plurality of processing cores, an overloaded processing core to rebalance. The internal flow traffic controller 150 is configured to identify a subject flow to move from the overloaded processing core. The internal flow traffic controller 150 is configured to identify a target processing core with a lowest utilization. The internal flow traffic controller 150 is configured to migrate processing of the subject flow from the overloaded processing core to the target processing core.

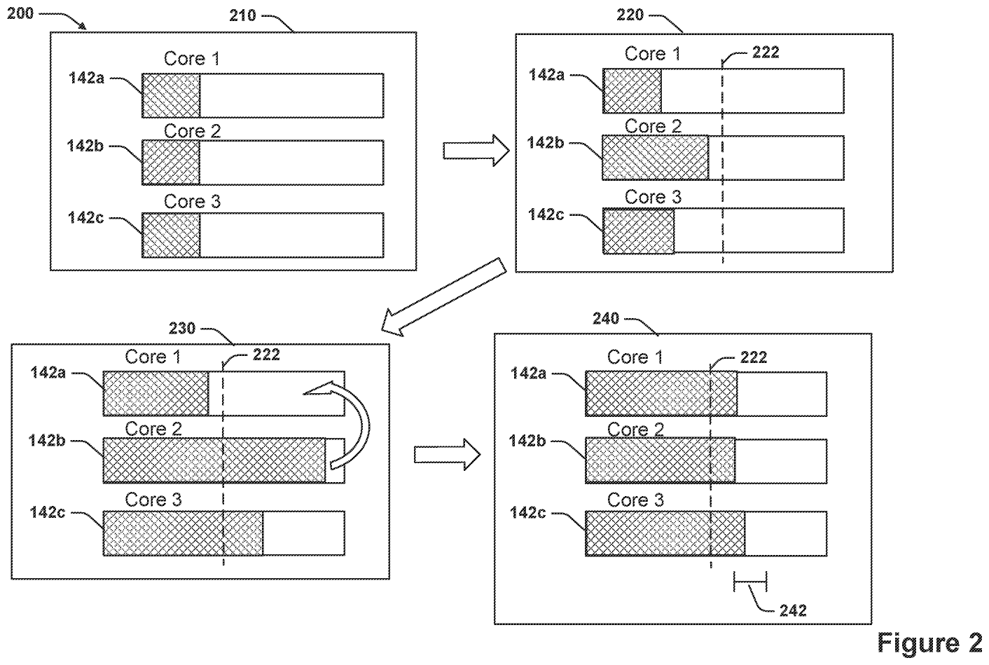

FIG. 2 is a diagram 200 showing load imbalance among processing cores 142. For simplicity, three processing cores are illustrated at each point in time. It should be understood that a multi-core system 140 may include a larger number of cores.

At a first time 210, each of the cores 142 has a relatively equal load. At a later time 220, the load on the cores 142 may start to become skewed. For example, a large persistent flow may be processed by the second packet handler core 142b such that the second packet handler core 142b has a larger load than the other cores 142. In some implementations, the load on second packet handler core 142b may remain below a utilization threshold 222, so performance may not be impacted. Rebalancing may not be initiated at time 220, for example, to avoid overhead of migrating a flow.

At a third time 230, the skew of the cores 142 may have increased. For example, the load on second packet handler core 142b may exceed the utilization threshold 222. For instance, one or more additional high volume flows may have been assigned to second packet handler core 142b while lower volume or shorter duration flows were assigned to the other cores 142. In some implementations, the load on the second packet handler core 142b exceeding the utilization threshold 222 may trigger flow rebalancing. In an aspect, the internal flow traffic controller 150 may migrate one or more flows from the second packet handler core 142b to a target core. In some implementations, the target core may be the first packet handler core 142a with the least load.

At a fourth time 240, the flow rebalancing may be complete. In some implementations, the load for one or more of the cores 142 may be greater than the utilization threshold 222, but there may be little or no skew between the cores 142. In some implementations, load rebalancing may be performed when one or more the utilization score greater than the utilization threshold 222 and a deviation from an average utilization score of the plurality of processing cores is greater than a second threshold 242. Accordingly, rebalancing may not be performed at the fourth time 240 because the deviation of each of the cores 142 from the average load is less than the second threshold 242.

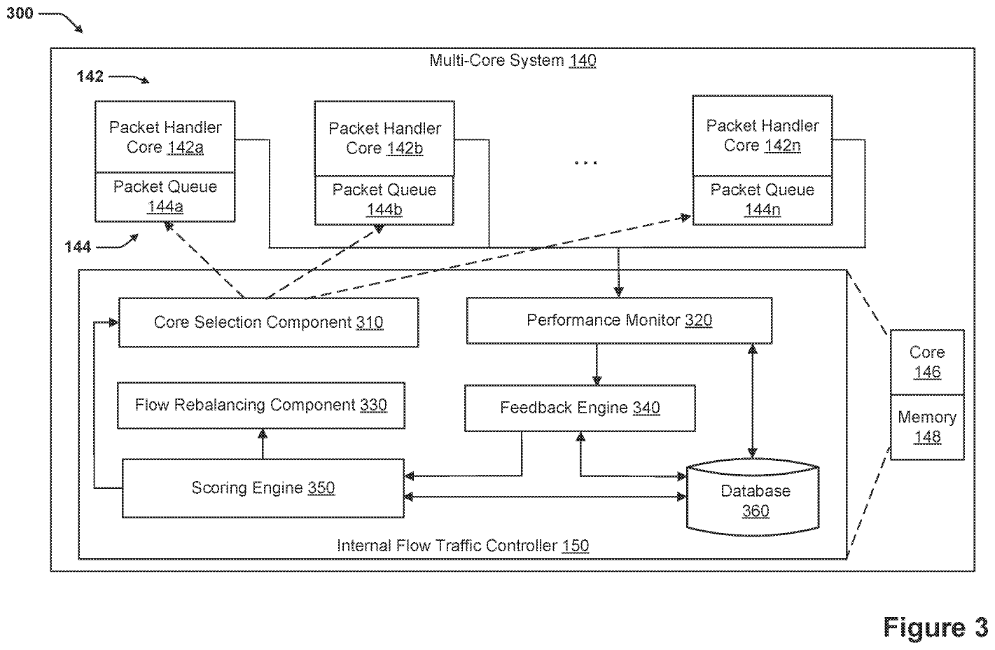

FIG. 3 is a diagram 300 of an example of a multi-core system 140 with an internal flow traffic controller 150. The multi-core system 140 may include a plurality of processing cores 142 including packet handler cores 142a-142n. In some implementations, each of the packet handler cores 142a-142n may be associated with a respective packet queue 144 (e.g., packet queues 144a-144n).

In some implementations, the multi-core system 140 may include a processing core 146 that executes the internal flow traffic controller 150. For example, the internal flow traffic controller 150 and each of the plurality of processing cores 142 may be a vCPU. A memory 148 is configured to store computer-executable instructions or other parameters related to providing multi-core system 140, which can execute one or more applications or processes, such as, but not limited to, the internal flow traffic controller 150 and the packet processing thread of execution for each packet handler core 142. For example, core 146 and memory 148 may be separate components communicatively coupled by a bus (e.g., on a motherboard or other portion of a computing device, on an integrated circuit, such as a system on a chip (SoC), etc.), components integrated within one another (e.g., a core 146 can include the memory 148 as an on-board component), and/or the like. Memory 148 may store instructions, parameters, data structures, etc. for use/execution by core 146 to perform functions described herein. In some implementations, the memory 148 includes a database 360 for use by the multi-core system 140.

The internal flow traffic controller 150 may include a core selection component 310, a performance monitor 320, a flow rebalancing component 330, a feedback engine 340, a scoring engine 350, and the database 360.

The performance monitor 320 may be configured to capture and store current states of the plurality of processing cores 142. The performance monitor 320 may measure and monitor degradation (or upgradation) of a core 142 using a core performance metric such as CPU utilization, packets per second (PPS), outstanding queue depth, errors detected, burst delay, total packets, etc. The performance monitor 320 may also track metrics for flows. A flow-id is a unique identifier for a flow based on n-tuples (src IP, dst IP, src port, dst port, protocol, network context, etc.). A normalized flow weight is the total bandwidth consumed by a flow in both uplink and downlink directions. Flow weight can also be configured as total packets processed by a flow. In general, flow-weight can be used as a normalized flow weight between 0-1. In an implementation, a core utilization metric may be an exponentially weighted moving average (EWMA) of the CPU utilization of a core for a set period (T). The core utilization will be used to identify the source and target cores. The performance monitor 320 may store the core performance metrics in database 360. The performance monitor 320 may also provide core performance metrics to feedback engine 340.

The scoring engine 350 is configured to use a dynamic scoring algorithm to calculate a utilization score for each core. In some implementation, a lower utilization score implies a better fit core for a new flow, and vice versa. In an implementation, the dynamic scoring algorithm predicts a future core score every time a new flow arrives. The future core score may estimate a core score after the flow is added. A total score may be estimated using the future core score along with a current core score (e.g., core utilization). After the total score is estimated, the best core is selected for the flow.

Taking into account the core performance indicators such as processing time, PPS, queue depth, burst delays, etc., the scoring engine 350 can model the dynamic score of each core as the weighted sum of these parameters. For example, a utilization function, U, may be expressed by the following equation:

$$\\ \begin{matrix}U = {a}_{1} {x}_{1} + {a}_{2} {x}_{2} + … + {a}_{n} {x}_{n} , & ( 1 )\end{matrix}$$

where xi is core performance indicator and a; is a respective weight.

The feedback engine 340 is configured to collect inputs from various modules such as the performance monitor 320, scoring engine 350, and so on. For example, the feedback engine may aggregate core performance metrics over a period of time. In an aspect, the feedback engine 340 evaluates estimated future core scores. When the real feedback is received about the core performance and flow details, the feedback engine 340 adjusts the core score. In the next iteration, the scoring engine 350 and core selection component 310 use the adjusted score. The feedback process of score adjustment is a slow path process that occurs every time, T. The feedback engine 340 may store a delta between a measured core utilization metric and the estimated score every time T. In some implementations, the feedback engine 340 may adjust scores. For example, a seasonable adjustment may adjust the score by the delta between the estimated and actual scores to improve the calculation over time. As another example, a dynamic adjustment may use a histogram to create bins of percentage values. The feedback engine 340 may estimate a target bin for a flow and continuously update the estimated histogram. After a period of time, when actual feedback is reported, the feedback engine may find a discrepancy between the estimated score based on the histogram and the actual measured core utilization metric. The feedback engine 340 may adjust the core score based on the discrepancy.

In some implementations, the feedback engine 340 may adjust a metric such as a normalized flow rate when a flow is migrated. For example, reducing the normalized flow rate for the migrated flow may prevent the migrated flow from being selected for migration again, thereby preventing a ping-pong effect. In some implementations, an adjustment factor used to reduce the migrated flow may be reduced over a plurality of maintenance cycles such that the migrated flow may be selected again after a period of time.

In some implementations, the feedback engine 340 may estimate an end time of a flow using heuristic rules, machine learning, historical data or a combination of these techniques. Estimated end time of the flow may be used to identify the flows that can be rebalanced. For example, an ideal flow to be rebalanced may be a flow whose current age is less than a threshold percentage of the estimated end time (e.g., its estimated half lifetime). Use of the estimated end time may prevent a ping-pong effect of a flow being migrated back and forth between two cores. In some implementations, the feedback engine 340 may calculate an error rate of the scoring engine 350. Further, the feedback engine 340 stores these parameters in the database 360 and reports these parameters to the scoring engine 350 and the flow rebalancing component 330.

The core selection component 310 is configured to select one of the plurality of processing cores 142 for a new flow. In some implementations, the core selection component 310 may initially use a hashing algorithm until the utilization scores for the plurality of processing cores 142 are known. Once the scoring engine 350 generates the utilization scores, the core selection component 310 may use the output from the scoring engine 350 to select an existing core that is best suited to the new flow at that time instant. For example, the core selection component 310. For example, the core selection component 310 may utilize a Mixed-Integer Programming (MIP) problem that jointly optimizes the core selection decisions, and core performance. The MIP may utilize the delta stored by the feedback engine. The objective function is to minimize the delta. All the scores may be normalized between 0 and 1. If the MIP is infeasible, the core selection component 310 may use the original hashing algorithm. The core selection component 310 may also use the input from the flow rebalancing component 330 for selecting a core for a new flow.

The flow rebalancing component 330 is configured to determine whether flow rebalancing is needed. For example, the flow rebalancing component 330 may compare flow utilization metrics to the utilization threshold 222 and/or the second threshold 242. The flow rebalancing component 330 may determine an overloaded core and a target core. In some implementations, the 330 may identify one or more subject flows to be migrated between cores 142.

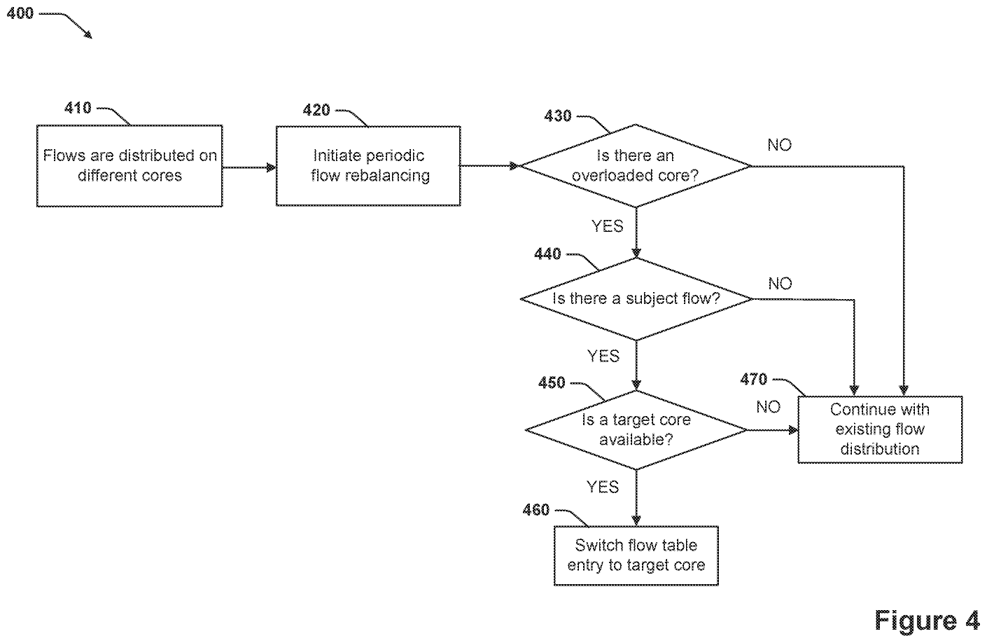

FIG. 4 is a logical flow diagram of a process 400 for flow rebalancing in a multi-core system 140. The process 400 may be performed by the internal flow traffic controller 150 and/or components thereof.

At block 410, the flows are distributed on different cores. For example, the core selection component 310 may distribute the flows to the core 142 based on a hashing algorithm.

At block 420, the internal flow traffic controller 150 may initiate periodic flow rebalancing. For example, the scoring engine 350 may have sufficient data to generate a utilization score for each core 142.

At block 430, the flow rebalancing component 330 may determine whether there is an overloaded core. For example, the flow rebalancing component 330 may compare the utilization score for each core 142 to the utilization threshold 222. If the core utilization of the current core is above the utilization threshold 222, the core is marked as an imbalanced core, and stored in a sorted list. The flow rebalancing component 330 may also determine deviation of the utilization score from an average utilization score and compare to the second threshold 242. If both thresholds are satisfied, the process may proceed to block 440. If one or both thresholds are not satisfied, the process may proceed to block 470.

At block 440, the flow rebalancing component 330 may determine whether there is a subject flow. For example, a subject flow may be a flow that has a greatest normalized flow rate among flows assigned to an overloaded core. For example, the flow rebalancing component 330 may check all flows among the sorted list of overloaded cores. In some implementations, the subject flow may also be based on a current age and/or estimated end time for a flow. For example, a flow may not be considered a subject flow if the current age is more than a threshold percentage of the estimated end time of the flow. That is, if the flow is expected to end soon, the flow rebalancing component 330 may not select that flow as the subject flow because migrating the flow shortly before the end may incur unnecessary overhead. If there is no subject flow, the process 400 may proceed to block 470. If there is a subject flow, the process 400 may proceed to block 450.

At block 450, flow rebalancing component 330 may determine whether a target core is available. For example, the target core may be a core with the lowest utilization. For example, the target core may have the lowest utilization score. In some implementations, a target core may not be available if the utilization score is greater than the utilization threshold. That is, if all of the cores are overloaded, migrating a flow to a different core may not improve performance. If there is no target core available, the process 400 may proceed to block 470. If there is a target core available, the process 400 may proceed to block 460.

At block 460, the flow rebalancing component 330 may switch a flow table entry for the subject flow to the target core. The flow table may indicate to which core an incoming packet for a flow is routed. For example, the internal flow traffic controller 150 may place an incoming packet into one of the packet queues 144 based on the flow table. Accordingly, switching the flow table entry may cause new packets to be sent to the target core.

At block 470, the flow rebalancing component 330 may continue with the existing flow distribution. The internal flow traffic controller 150 may continue to route packets to processing cores 142 based on the current flow table. In some implementations, the process 400 may return to block 420 to periodically determine whether to perform flow rebalancing.

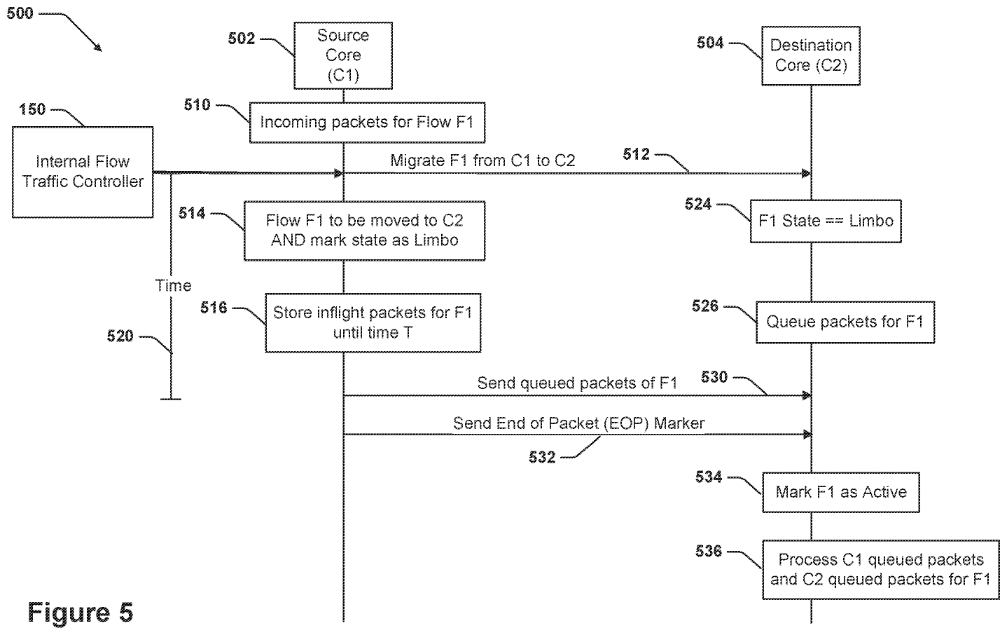

FIG. 5 is a message diagram 500 of processes and messages for migrating a flow from a source core 502 to a destination core 504. The source core 502 and the destination core 504 may both be examples of the packet processing cores 142. The source core 502 may be the overloaded core and the destination core 504 may be the target core. In an aspect, the internal flow traffic controller 150, the source core 502, and the destination core 504 may optionally implement a procedure for maintaining packet order using an end of packet (EOP) marker. The destination core 504 may queue packets for the migrated flow until the EOP marker is received from the source core 502.

Initially, at block 510, the source core 502 may receive and process incoming packets for flow F1. When the internal flow traffic controller 150 determines to migrate the flow F1, the internal flow traffic controller 150 may send an indication 512 to both the source core 502 and the destination core 504. The indication 512 may occur when the internal flow traffic controller 150 changes the flow table in block 460.

In response to the indication 512, the source core 502 may mark the flow F1 as being in a limbo state indicating that received packets are intended for processing at the destination core 504. Similarly, at block 524, the destination core 504 may add the flow F1 marked as being in the limbo state.

At block 516, the source core 502 may store inflight packets for F1 until a time 520 after the indication 512. Similarly, during the time 520, if the destination core 504 receives any packets for F1, the destination core 504 may queue the packets for F1.

At the end of time 520, the source core 502 may send the queued packets 530 of F1 to the destination core 504. The source core 502 may send the EOP marker 532 after the last queued packet 530.

When the destination core 504 receives the EOP marker 532, the destination core 504 may mark F1 as being in an active status at block 534. At block 536, the destination core 504 may then process the queued packets 530 from the source core 502 followed by the locally queued packets for F1. Accordingly, the packets for F1 will be processed in the correct order.

In some implementations, where order preservation is not enabled, the destination core 504 may immediately start processing packets for F1 after the indication 512 without using the limbo status. The source core 502 may still send any queued packets for F1 and the EOP marker 532.

FIG. 6 is a flow diagram of an example of a method 600 for redirecting packets with stateful flow awareness among a plurality of processing cores. For example, the method 600 can be performed by the multi-core system 140, the internal flow traffic controller 150, and/or one or more components thereof to redirect packets with stateful flow awareness among a plurality of processing cores 142.

At block 610, the method 600 includes distributing new incoming flows of network traffic to one of the plurality of processing cores. In an example, the internal flow traffic controller 150, e.g., in conjunction with core 146 and memory 148 can execute the core selection component 310 to distribute new incoming flows 160 of network traffic to one of the plurality of processing cores 142. In some implementations, at sub-block 612, the block 610 may optionally include selecting a processing core (e.g., packet handler core 142a) based on the utilization score of each of the plurality of processing cores. For example, the core selection component 310 may select a core 142 with the lowest utilization score, or may solve a MIP problem for the best core 142.

At block 620, the method 600 includes identifying, based on an imbalance among the plurality of processing cores, an overloaded processing core to rebalance. In an example, the internal flow traffic controller 150, e.g., in conjunction with core 146 and memory 148 can execute the scoring engine 350 to identify, based on an imbalance among the plurality of processing cores, an overloaded processing core to rebalance. In some implementations, at sub-block 622, the block 620 may optionally include measuring a utilization score of each of the plurality of processing cores 142. In some implementations, at sub-block 624, the block 620 may optionally include identifying the overloaded processing core as a processing core of the plurality of processing cores with the utilization score greater than a first threshold (e.g., utilization threshold 222) and a deviation from an average utilization score of the plurality of processing cores that is greater than a second threshold 642.

At block 630, the method 600 includes identifying a subject flow to move from the overloaded processing core. In an example, the internal flow traffic controller 150, e.g., in conjunction with core 146 and memory 148 can execute the flow rebalancing component 330 to identify a subject flow to move from the overloaded processing core. In some implementations, for example, at sub-block 632, the feedback engine 340 may measure a normalized flow rate for each flow 160 assigned to the overloaded processing core. In sub-block 634, the flow rebalancing component 330 may select a flow having a greatest normalized flow rate as the subject flow. In some implementations, at sub-block 636, the feedback engine 340 may estimate an end time for each flow 160 assigned to the overloaded processing core. At sub-block 638, the flow rebalancing component 330 may select a flow having a current age that is less than a threshold percentage of the estimated end time for the flow as the subject flow.

At block 640, the method 600 includes identifying a target processing core with a lowest utilization. In an example, the internal flow traffic controller 150, e.g., in conjunction with core 146 and memory 148 can execute the flow rebalancing component 330 to identify a target processing core with a lowest utilization.

At block 650, the method 600 includes migrating processing of the subject flow from the overloaded processing core to the target processing core. In an example, the internal flow traffic controller 150, e.g., in conjunction with core 146 and memory 148 can execute the flow rebalancing component 330 to migrate processing of the subject flow from the overloaded processing core (e.g., source core 502) to the target processing core (e.g., destination core 504).

At block 660, the method 600 may optionally include adjusting a second utilization score for a second period of time based on a difference between the estimate of the utilization metric for the first period of time and an actual utilization metric measured during the first period of time. In an example, the internal flow traffic controller 150, e.g., in conjunction with core 146 and memory 148 can execute the feedback engine 340 to adjust a second utilization score for a second period of time based on a difference between the estimate of the utilization metric for the first period of time and an actual utilization metric measured during the first period of time.

At block 670, the method 600 may optionally include reducing the normalized flow rate for the subject flow by an adjustment factor after migrating the subject flow. In an example, the internal flow traffic controller 150, e.g., in conjunction with core 146 and memory 148 can execute the feedback engine 340 to reduce the normalized flow rate for the subject flow by an adjustment factor after migrating the subject flow.

At block 680, the method 600 may optionally include reducing the adjustment factor over a plurality of maintenance cycles. In an example, the internal flow traffic controller 150, e.g., in conjunction with core 146 and memory 148 can execute the feedback engine 340 to reduce the adjustment factor over the plurality of maintenance cycles.

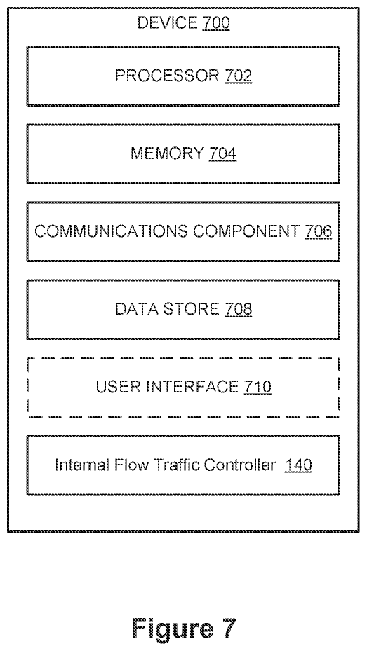

FIG. 7 illustrates an example of a device 700 including additional optional component details as those shown in FIG. 3. In one aspect, device 700 includes processor 702, which may include any of the cores described herein for carrying out processing functions associated with one or more of components and functions described herein. Processor 702 can include a single or multiple set of processors or multi-core processors. Moreover, processor 702 can be implemented as an integrated processing system and/or a distributed processing system.

Device 700 further includes memory 704, which may be similar to memory 148 such as for storing local versions of operating systems (or components thereof) and/or applications being executed by processor 702, such as the internal flow traffic controller 150, etc. Memory 704 can include a type of memory usable by a computer, such as random access memory (RAM), read only memory (ROM), tapes, magnetic discs, optical discs, volatile memory, non-volatile memory, and any combination thereof. The processor 702 may execute instructions stored on the memory 704 to cause the device 700 to perform the methods discussed above with respect to FIG. 6.

Further, device 700 includes a communications component 706 that provides for establishing and maintaining communications with one or more other devices, parties, entities, etc. utilizing hardware, software, and services as described herein. Communications component 706 carries communications between components on device 700, as well as between device 700 and external devices, such as devices located across a communications network and/or devices serially or locally connected to device 700. For example, communications component 706 may include one or more buses, and may further include transmit chain components and receive chain components associated with a wireless or wired transmitter and receiver, respectively, operable for interfacing with external devices.

Additionally, device 700 may include a data store 708, which can be any suitable combination of hardware and/or software, that provides for mass storage of information, databases, and programs employed in connection with aspects described herein. For example, data store 708 may be or may include a data repository for operating systems (or components thereof), applications, related parameters, etc. not currently being executed by processor 702. In addition, data store 708 may be a data repository for the multi-core system 140 and/or internal flow traffic controller 150.

Device 700 may optionally include a user interface component 710 operable to receive inputs from a user of device 700 and further operable to generate outputs for presentation to the user. User interface component 710 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 710 may include one or more output devices, including but not limited to a display, a speaker, a haptic feedback mechanism, a printer, any other mechanism capable of presenting an output to a user, or any combination thereof.

Device 700 additionally includes the multi-core system 140 for redirecting packets with stateful flow awareness among a plurality of processing cores; core selection component 310 for distributing new incoming flows of network traffic to one of the plurality of processing cores; performance monitor 320 for identifying, based on an imbalance among the plurality of processing cores, an overloaded processing core to rebalance; and identifying a subject flow to move from the overloaded processing core; a scoring engine 350 for identifying a target processing core with a lowest utilization; and a flow rebalancing component 330 for migrating processing of the subject flow from the overloaded processing core to the target processing core, etc.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. An internal flow traffic controller for redirecting packets with stateful flow awareness among a plurality of processing cores, comprising: a memory storing computer-executable instructions; and a processor configured to execute the computer-executable instructions to cause the internal flow traffic controller to: distribute new incoming flows of network traffic to one of the plurality of processing cores; identify, based on an imbalance among the plurality of processing cores, an overloaded processing core to rebalance; identify a subject flow to move from the overloaded processing core; identify a target processing core with a lowest utilization; and migrate processing of the subject flow from the overloaded processing core to the target processing core.

Clause 2. The internal flow traffic controller of clause 1, wherein to identify the overloaded processing core, the processor is configured to: measure a utilization score of each of the plurality of processing cores; and identify the overloaded processing core as a processing core of the plurality of processing cores with the utilization score greater than a first threshold and a deviation from an average utilization score of the plurality of processing cores that is greater than a second threshold.

Clause 3. The internal flow traffic controller of clause 2, wherein to distribute new incoming flows of network traffic to one of the plurality of processing cores, the processor is configured to select a processing core based on the utilization score of each of the plurality of processing cores.

Clause 4. The internal flow traffic controller of clause 2 or 3, wherein the utilization score is an estimate of a utilization metric over a first period of time, wherein the processor is configured to adjust a second utilization score for a second period of time based on a difference between the estimate of the utilization metric for the first period of time and an actual utilization metric measured during the first period of time.

Clause 5. The internal flow traffic controller of any of clauses 1-4, wherein to identify the subject flow to move from the overloaded processing core, the processor is configured to: measure a normalized flow rate for each flow assigned to the overloaded processing core; and select a flow having a greatest normalized flow rate as the subject flow.

Clause 6. The internal flow traffic controller of clause 5, wherein the processor is further configured to reduce the normalized flow rate for the subject flow by an adjustment factor after migrating the subject flow.

Clause 7. The internal flow traffic controller of clause 6, wherein the processor is further configured to reduce the adjustment factor over a plurality of maintenance cycles.

Clause 8. The internal flow traffic controller of any of clauses 1-7, wherein to identify the subject flow to move from the overloaded processing core, the processor is configured to: estimate an end time for each flow assigned to the overloaded processing core; and select a flow having a current age that is less than a threshold percentage of the estimated end time for the flow as the subject flow.

Clause 9. The internal flow traffic controller of any of clauses 1-8, wherein to migrate processing of the subject flow from the overloaded processing core to the target processing core, the processor is configured to: send an end of packet (EOP) marker from the internal flow traffic controller to the overloaded processing core, wherein the overloaded processing core is configured to send queued packets for the subject flow to the target processing core followed by the EOP marker; and update a flow table to assign new packets to the target processing core.

Clause 10. The internal flow traffic controller of clause 9, wherein the target processing core is configured to queue the new packets from the internal flow traffic controller until the EOP marker is received from the overloaded processing core when packet order preservation is enabled.

Clause 11. A method of redirecting packets with stateful flow awareness among a plurality of processing cores, comprising: distributing new incoming flows of network traffic to one of the plurality of processing cores; identifying, based on an imbalance among the plurality of processing cores, an overloaded processing core to rebalance; identifying a subject flow to move from the overloaded processing core; identifying a target processing core with a lowest utilization; and migrating processing of the subject flow from the overloaded processing core to the target processing core.

Clause 12. The method of clause 11, wherein identifying the overloaded processing core comprises: measuring a utilization score of each of the plurality of processing cores; and identifying the overloaded processing core as a processing core of the plurality of processing cores with the utilization score greater than a first threshold and a deviation from an average utilization score of the plurality of processing cores that is greater than a second threshold.

Clause 13. The method of clause 12, wherein distributing new incoming flows of network traffic to one of the plurality of processing cores comprises selecting a processing core based on the utilization score of each of the plurality of processing cores.

Clause 14. The method of clause 12 or 13, wherein the utilization score is an estimate of a utilization metric over a first period of time, further comprising adjusting a second utilization score for a second period of time based on a difference between the estimate of the utilization metric for the first period of time and an actual utilization metric measured during the first period of time.

Clause 15. The method of any of clauses 11-14, wherein identifying the subject flow to move from the overloaded processing core comprises: measuring a normalized flow rate for each flow assigned to the overloaded processing core; and selecting a flow having a greatest normalized flow rate as the subject flow.

Clause 16. The method of clause 15, further comprising reducing the normalized flow rate for the subject flow by an adjustment factor after migrating the subject flow.

Clause 17. The method of clause 16, further comprising reducing the adjustment factor over a plurality of maintenance cycles.

Clause 18. The method of any of clauses 11-17, wherein identifying the subject flow to move from the overloaded processing core comprises: estimating an end time for each flow assigned to the overloaded processing core; and selecting a flow having a current age that is less than a threshold percentage of the estimated end time for the flow as the subject flow.

Clause 19. The method of any of clauses 11-18, migrating processing of the subject flow from the overloaded processing core to the target processing core comprises: send an end of packet (EOP) marker to the overloaded processing core, wherein the overloaded processing core is configured to send queued packets for the subject flow to the target processing core followed by the EOP marker; and update a flow table to assign new packets to the target processing core.

Clause 20. A non-transitory computer-readable medium storing computer-executable instructions, that when executed by a processor including a plurality of processing cores, cause the processor to: distribute new incoming flows of network traffic to one of the plurality of processing cores; identify, based on an imbalance among the plurality of processing cores, an overloaded processing core to rebalance; identify a subject flow to move from the overloaded processing core; identify a target processing core with a lowest utilization; and migrate processing of the subject flow from the overloaded processing core to the target processing core.

Clause 21. The non-transitory computer-readable medium storing computer-executable instructions, that when executed by a processor including a plurality of processing cores, cause the processor to perform the method of any of clauses 11-19.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An internal flow traffic controller for redirecting packets with stateful flow awareness among a plurality of processing cores, comprising:
a memory storing computer-executable instructions; and
a processor configured to execute the computer-executable instructions to cause the internal flow traffic controller to:
distribute new incoming flows of network traffic to one of the plurality of processing cores;
measure a utilization score of each of the plurality of processing cores;
identify, based on an imbalance among the plurality of processing cores, an overloaded processing core to rebalance, the overloaded processing core having a utilization score greater than a first threshold and a deviation from an average utilization score of the plurality of processing cores that is greater than a second threshold;
identify a subject flow to move from the overloaded processing core;
identify a target processing core with a lowest utilization; and
migrate processing of the subject flow from the overloaded processing core to the target processing core.

2. The internal flow traffic controller of claim 1, wherein to distribute new incoming flows of network traffic to one of the plurality of processing cores, the processor is configured to select a processing core based on the utilization score of each of the plurality of processing cores.

3. The internal flow traffic controller of claim 1, wherein the utilization score is an estimate of a utilization metric over a first period of time, wherein the processor is configured to adjust a second utilization score for a second period of time based on a difference between the estimate of the utilization metric for the first period of time and an actual utilization metric measured during the first period of time.

4. The internal flow traffic controller of claim 1, wherein to identify the subject flow to move from the overloaded processing core, the processor is configured to:
measure a normalized flow rate for each flow assigned to the overloaded processing core; and
select a flow having a greatest normalized flow rate as the subject flow.

5. The internal flow traffic controller of claim 4, wherein the processor is further configured to reduce the normalized flow rate for the subject flow by an adjustment factor after migrating the subject flow.

6. The internal flow traffic controller of claim 5, wherein the processor is further configured to reduce the adjustment factor over a plurality of maintenance cycles.

7. The internal flow traffic controller of claim 1, wherein to identify the subject flow to move from the overloaded processing core, the processor is configured to:
estimate an end time for each flow assigned to the overloaded processing core; and
select a flow having a current age that is less than a threshold percentage of the estimated end time for the flow as the subject flow.

8. The internal flow traffic controller of claim 1, wherein to migrate processing of the subject flow from the overloaded processing core to the target processing core, the processor is configured to:
send an end of packet (EOP) marker from the internal flow traffic controller to the overloaded processing core, wherein the overloaded processing core is configured to send queued packets for the subject flow to the target processing core followed by the EOP marker; and
update a flow table to assign new packets to the target processing core.

9. The internal flow traffic controller of claim 8, wherein the target processing core is configured to queue the new packets from the internal flow traffic controller until the EOP marker is received from the overloaded processing core when packet order preservation is enabled.

10. The internal flow traffic controller of claim 1, wherein the flows of network traffic are for a packet forwarding node of a 5G network or beyond.

11. A method of redirecting packets with stateful flow awareness among a plurality of processing cores, comprising:
distributing new incoming flows of network traffic to one of the plurality of processing cores;
measuring a utilization score of each of the plurality of processing cores;
identifying, based on an imbalance among the plurality of processing cores, an overloaded processing core to rebalance as a processing core of the plurality of processing cores with the utilization score greater than a first threshold and a deviation from an average utilization score of the plurality of processing cores that is greater than a second threshold;
identifying a subject flow to move from the overloaded processing core;
identifying a target processing core with a lowest utilization; and
migrating processing of the subject flow from the overloaded processing core to the target processing core.

12. The method of claim 11, wherein distributing new incoming flows of network traffic to one of the plurality of processing cores comprises selecting a processing core based on the utilization score of each of the plurality of processing cores.

13. The method of claim 11, wherein the utilization score is an estimate of a utilization metric over a first period of time, further comprising adjusting a second utilization score for a second period of time based on a difference between the estimate of the utilization metric for the first period of time and an actual utilization metric measured during the first period of time.

14. The method of claim 11, wherein identifying the subject flow to move from the overloaded processing core comprises:
measuring a normalized flow rate for each flow assigned to the overloaded processing core; and
selecting a flow having a greatest normalized flow rate as the subject flow.

15. The method of claim 14, further comprising reducing the normalized flow rate for the subject flow by an adjustment factor after migrating the subject flow.

16. The method of claim 15, further comprising reducing the adjustment factor over a plurality of maintenance cycles.

17. The method of claim 11, wherein identifying the subject flow to move from the overloaded processing core comprises:
estimating an end time for each flow assigned to the overloaded processing core; and
selecting a flow having a current age that is less than a threshold percentage of the estimated end time for the flow as the subject flow.

18. The method of claim 11, migrating processing of the subject flow from the overloaded processing core to the target processing core comprises:
send an end of packet (EOP) marker to the overloaded processing core, wherein the overloaded processing core is configured to send queued packets for the subject flow to the target processing core followed by the EOP marker; and
update a flow table to assign new packets to the target processing core.

19. The method of claim 11, wherein the flows of network traffic are for a packet forwarding node of a 5G network or beyond.

20. A non-transitory computer-readable medium storing computer-executable instructions, that when executed by a processor including a plurality of processing cores, cause the processor to:
distribute new incoming flows of network traffic to one of the plurality of processing cores;
measure a utilization score of each of the plurality of processing cores;
identify, based on an imbalance among the plurality of processing cores, an overloaded processing core to rebalance, the overloaded processing core having a utilization score greater than a first threshold and a deviation from an average utilization score of the plurality of processing cores that is greater than a second threshold;
identify a subject flow to move from the overloaded processing core;
identify a target processing core with a lowest utilization; and
migrate processing of the subject flow from the overloaded processing core to the target processing core.
